(19) United States
(12) Patent Application Publication
(10) Pub. No.: US 2016/0230954 A1
(43) Pub. Date: Aug. 11, 2016

(54) OPTICAL DEVICE AND A LIGHT SOURCE MODULE HAVING THE SAME

(71) Applicant: SAMSUNG ELECTRONICS CO., LTD., SUWON-SI (KR)

(72) Inventors: SANG WOO HA, SEONGNAM-SI (KR); WON SOO JI, HWASEONG-SI (KR); JONG PIL WON, YONGIN-SI (KR)

(21) Appl. No.: 14/976,273

(22) Filed: Dec. 21, 2015

(30) Foreign Application Priority Data
Feb. 9, 2015 (KR) 10-2015-0019466

(51) Int. Cl. F21V 5/04; F21K 99/00

(52) U.S. Cl. CPC F21V 5/048; F21K 9/50; F21Y 2101/02

(57) ABSTRACT

An optical device includes a first surface including a light incident surface onto which light is incident, and a second surface which emits light passing through the light incident surface. The light incident surface includes a first curved surface and a second curved surface. The first curved surface is disposed in a recess in a central portion of the light incident surface and recessed toward the second surface, the second curved surface being connected to the first curved surface in the recess and extended from the recess. The first and second curved surfaces have an inflection point at a contact point at which the first and second curved surfaces contact each other. The second surface opposes the first surface, and the first and second surfaces form a biconvex lens structure.

### CROSS-REFERENCE TO RELATED APPLICATION

This application claims priority under 35 U.S.C. §119 to Korean Patent Application No. 10-2015-0019466, filed on Feb. 9, 2015, in the Korean Intellectual Property Office, the disclosure of which is incorporated by reference herein in its entirety.

### TECHNICAL FIELD

The present inventive concept relates to an optical device and a light source module having the same.

### DISCUSSION OF THE RELATED ART

A wide-beam angle lens is a type of lens used in light emitting device packages to allow light to be widely diffused. Light incident to a central portion of the wide-beam angle lens is diffused laterally by refraction. However, in a case in which the light incident to the lens is not uniformly distributed due to various types of light sources included in light emitting device packages, a partial increase in brightness distribution may occur. As such, optical non-uniformity defects such as Mura may occur.

### SUMMARY

According to an exemplary embodiment of the present inventive concept, an optical device includes a first surface including a light incident surface onto which light is incident, and a second surface which emits light passing through the light incident surface. The light incident surface includes a first curved surface and a second curved surface. The first curved surface is disposed in a recess in a central portion of the light incident surface and recessed toward the second surface, the second curved surface being connected to the first curved surface in the recess and extended from the recess. The first and second curved surfaces have an inflection point at a contact point at which the first and second curved surfaces contact each other. The second surface opposes the first surface, and the first and second surfaces form a biconvex lens structure.

In an exemplary embodiment of the present inventive concept, an optical axis passes through the recess.

In an exemplary embodiment of the present inventive concept, a shape of the light incident surface satisfies conditions 1 to 3:

Condition 1: dR/dθ<0 for θ≦55°

Condition 2: dR/dθ=0 for 55°<θ<65°

Condition 3: dR/dθ>0 for 65°≦θ

where, when an intersection point between an optical axis passing through the recess and a light emission surface of a light source is defined as a reference point “O”, “R” refers to a straight line connecting the reference point and a point of the light incident surface to each other, and “θ” refers to an angle formed by the straight line “R” with respect to the optical axis.

In an exemplary embodiment of the present inventive concept, the shape of the light incident surface satisfies conditions 4 to 6:

Condition 4: θ2/θ1>1 for θ1≦55°

Condition 5: θ2/θ1=1 for 55°<θ1<65°

Condition 6: θ2/θ1<1 for 65°≦θ1

where “θ1” refers to a light emission angle formed by light emitted from the light source with respect to the optical axis, and “θ2” refers to a refraction angle of the light having the light emission angle “θ1”, which is refracted from the light incident surface toward the second surface, with respect to the optical axis.

In an exemplary embodiment of the present inventive concept, the optical device further includes a flange portion disposed between the first surface and the second surface at an edge of the optical device, and a thickness “Tf” of the optical device measured from a bottom surface of the optical device to a center of the flange portion in a vertical direction corresponds to ⅓ to ½ of an overall thickness “Tt” of the optical device.

In an exemplary embodiment of the present inventive concept, when an intersection point between an optical axis passing through the recess and a light emission surface of a light source is a reference point “O”, a first ray of light emitted from “O” and having a first angle with respect to the optical axis is refracted downward by the light incident surface, and a second ray of light emitted from “O” and having a second angle with respect to the optical axis is refracted upward by the light incident surface. The first angle is smaller than the second angle.

In an exemplary embodiment of the present inventive concept, the second surface includes a concave portion recessed toward the recess of the first surface, and a convex portion extended from an edge of the concave portion to an edge of the optical device.

In an exemplary embodiment of the present inventive concept, the optical device further includes a support portion disposed on the first surface.

According to an exemplary embodiment of the present inventive concept, an optical device includes a first surface including a recess disposed in a central portion of the first surface, and a second surface that faces the first surface to form a biconvex lens. The recess is recessed toward the second surface and includes a light incident surface onto which light is incident. The light incident surface includes a first curved surface and a second curved surface, the first curved surface being disposed in the recess in the central portion of the first surface and recessed toward the second surface, the second curved surface being connected to the first curved surface in the recess and extended from the recess. The first and second curved surfaces have an inflection point at a contact point at which the first and second curved surfaces contact each other.

In an exemplary embodiment of the present inventive concept, a sidewall of the recess has an approximate S-shaped vertical cross-section.

According to an exemplary embodiment of the present inventive concept, a light source module includes a light source, and an optical device including a first surface and a second surface. The first surface is disposed above the light source and includes a recess formed in a central portion of the first surface and recessed toward the second surface, and the second surface opposes the first surface to form a biconvex lens. Wherein the recess includes a light incident surface onto which light from the light source is incident. The light incident surface includes a first curved surface and a second curved surface, the first curved surface being disposed in the recess in the central portion of the first surface and recessed toward the second surface, the second curved surface being connected to the first curved surface in the recess and extended from the recess. The first and second curved surfaces have an inflection point at a contact point where the first and second curved surfaces contact each other.

In an exemplary embodiment of the present inventive concept, a size of an opening of the recess is greater than a size of the light source.

In an exemplary embodiment of the present inventive concept, the light source is a light emitting diode (LED) chip or a light emitting diode package in which the light emitting diode chip is disposed.

In an exemplary embodiment of the present inventive concept, the light source includes an encapsulation part encapsulating the light emitting diode chip.

In an exemplary embodiment of the present inventive concept, the light source module further includes a substrate on which the light source and the optical device are disposed.

According to an exemplary embodiment of the present inventive concept, an optical device includes a first surface comprising, in cross-sectional view, a first convex portion, a second convex portion, and a first concave portion disposed therebetween, and a second surface comprising, in the cross-sectional view, a third convex portion, a fourth convex portion, and a second concave portion disposed therebetween. The first surface and the second surface face each other. The first concave portion and the second concave portion protrude toward each other. The first concave portion includes a first sidewall and a second sidewall that face each other. The first sidewall includes a first region and a second region. Light passing through the first region is refracted downward with respect to its original direction, and light passing through the second region is refracted upward with respect to its original direction.

In an exemplary embodiment of the present inventive concept, the first region of the first sidewall forms a bottom of a recess and the second region of the first sidewall forms an opening of the recess.

In an exemplary embodiment of the present inventive concept, the first surface and the second surface are connected to each other with a pair of flanges.

In an exemplary embodiment of the present inventive concept, light is emitted through the first surface to the second surface.

In an exemplary embodiment of the present inventive concept, the light is incident to the first concave portion of the first surface.

### BRIEF DESCRIPTION OF THE DRAWINGS

The above and other features of the present inventive concept will become more apparent by describing in detail exemplary embodiments thereof in conjunction with the accompanying drawings, in which:

FIG. 1 is a schematic perspective view of a light source module including an optical device, according to an exemplary embodiment of the present inventive concept;

FIG. 2 is a cross-sectional view of FIG. 1, according to an exemplary embodiment of the present inventive concept;

FIG. 3 is a cross-sectional view schematically illustrating an enlarged light incident surface of the optical device of FIG. 2, according to an exemplary embodiment of the present inventive concept;

FIG. 4 is a cross-sectional view illustrating a relationship between an angle of incidence and a refraction angle of the light incident surface of the optical device of FIG. 3, according to an exemplary embodiment of the present inventive concept;

FIG. 5 is a cross-sectional view schematically illustrating an optical path of light emitted from the light source of FIG. 2 and passing through the optical device of FIG. 2, according to an exemplary embodiment of the present inventive concept;

FIG. 6A is a cross-sectional view schematically illustrating an optical path of light refracted at a first surface of the optical device of FIG. 2 and emitted externally, according to an exemplary embodiment of the present inventive concept;

FIG. 6B is a cross-sectional view schematically illustrating an optical path of light refracted at a first surface of the optical device of FIG. 2 and emitted externally, according to an exemplary embodiment of the present inventive concept;

FIG. 7A is a cross-sectional view schematically illustrating a light source module, according to an exemplary embodiment of the present inventive concept;

FIG. 7B is a plan view schematically illustrating the light source module of FIG. 7A, according to an exemplary embodiment of the present inventive concept;

FIG. 8 is a schematic perspective view illustrating a state in which a light source and an optical device are mounted on a substrate of FIG. 7A, according to an exemplary embodiment of the present inventive concept;

FIG. 9 is a cross-sectional view schematically illustrating a light source, according to an exemplary embodiment of the present inventive concept;

FIG. 10 illustrates a CIE 1931 chromaticity coordinates system for illustrating a wavelength conversion material employable in an exemplary embodiment of the present inventive concept;

FIG. 11 is a schematic diagram illustrating a cross-sectional structure of a quantum dot (QD), according to an exemplary embodiment of the present inventive concept;

FIG. 12 is a cross-sectional view illustrating a light emitting diode (LED) chip used as a light source, according to an exemplary embodiment of the present inventive concept;

FIG. 13A is a plan view illustrating an LED chip used as a light source, according to an exemplary embodiment of the present inventive concept;

FIG. 13B is a side cross-sectional view of the LED chip of FIG. 13A, taken along line I-I′ of FIG. 13A, according to an exemplary embodiment of the present inventive concept;

FIG. 14 is a cross-sectional view illustrating an LED chip used as a light source, according to an exemplary embodiment of the present inventive concept;

FIG. 15 is a schematic perspective view and a cross-sectional view illustrating an LED chip, according to an exemplary embodiment of the present inventive concept;

FIG. 16 is a schematic cross-sectional view of a lighting device, according to an exemplary embodiment of the present inventive concept;

FIG. 17 is a schematic exploded perspective view of a bulb-type lighting device, according to an exemplary embodiment of the present inventive concept; and

FIG. 18 is a schematic exploded perspective view of a bar type lighting device, according to an exemplary embodiment of the present inventive concept;

### DETAILED DESCRIPTION OF THE EMBODIMENTS

Exemplary embodiments of the present inventive concept will now be described more fully hereinafter with reference to the accompanying drawings. The present inventive concept may, however, be embodied in different forms and should not be construed as limited to the embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected, or coupled to the other element or layer, or intervening elements or layers may be present.

As used herein, the singular forms “a,” “an” and “the” are intended to include the plural forms as well, unless the context clearly indicates otherwise. It will be further understood that terms such as those defined in commonly used dictionaries should be interpreted as having a meaning that is consistent with their meaning in the context of the relevant art and will not be interpreted in an idealized or overly formal sense unless expressly so defined herein.

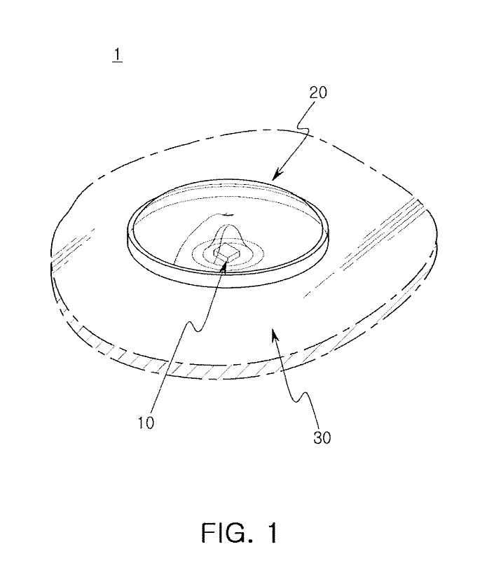

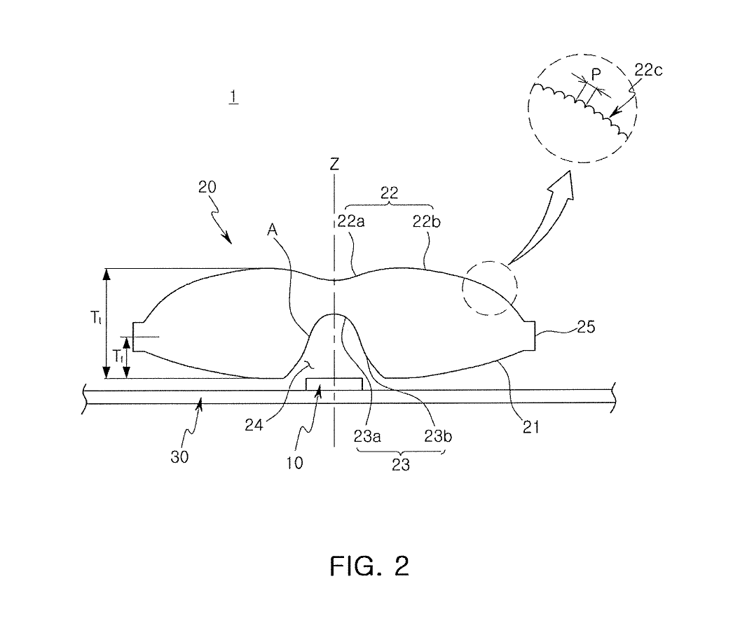

With reference to FIGS. 1 and 2, optical light source module including an optical device according to an exemplary embodiment of the present inventive concept will be described. FIG. 1 is a schematic perspective view of a light source module including an optical device, according to an exemplary embodiment of the present inventive concept. FIG. 2 is a cross-sectional view of FIG. 1, according to an exemplary embodiment of the present inventive concept.

With reference to FIGS. 1 and 2, a light source module 1, according to an exemplary embodiment of the present inventive concept, may include a light source 10 and an optical device 20 disposed above the optical source 10. In addition, the light source module 1 may include a substrate 30 on which the light source 10 and the optical device 20 are mounted.

The light source 10 may be provided as a photoelectric device for generating light having a predetermined wavelength through externally-supplied driving power. For example, the light source 10 may include a semiconductor light emitting diode (LED) having an n-type semiconductor layer, a p-type semiconductor layer, and an active layer disposed therebetween.

The light source 10 may emit blue light, green light or red light, according to a material contained in the light source 10 or according to a combination of phosphor with a material contained in the light source 10. The light source 10 may also emit white light, ultraviolet light, or the like. A detailed configuration and structure of the light source 10 will be described in detail below.

The optical device 20 may be disposed above the light source 10 to cover the light source 10. The optical device 20 may adjust an angle in a spread of beams of light emitted from the light source 10. For example, the optical device 20 may include a wide-beam angle lens implementing a wide angle in a spread of light beams by allowing beams of light emitted by the light source 10 to be widely spread.

FIGS. 2 to 4 illustrate the optical device 20, according to an exemplary embodiment of the present inventive concept. As illustrated in FIG. 2, the optical device 20 may include a first surface 21 having a light incident surface 23 onto which light emitted from the light source 10 is incident, and a second surface 22 for emitting the light transmitted to the optical device 20 through the light incident surface 23 externally.

The optical device 20 may include a flange portion 25 corresponding to an outer edge of the optical device 20 between the first surface 21 and the second surface 22. The flange portion 25 may be formed as an outermost protruding portion and may have a predetermined thickness along a circumference of the optical device 20. The first surface 21 and the second surface 22 may include the flange portion 25 therebetween and may be separated from each other by the flange portion 25.

The optical device 20 may have a substantially biconvex lens structure in which the first surface 21 facing the light source 10 protrudes in a direction toward the light source 10 in a convex manner. The second surface 22 opposing the first surface 21 protrudes in a direction opposite to a direction in which the first surface 21 protrudes, in a convex manner. In other words, the optical device 20 may have a biconvex shape along a plane that is substantially perpendicular to the optical axis Z. The biconvex shape includes the first surface 21 which is a convex surface and the second surface 22 which is also a convex surface and opposite to the first surface 21. Light emitted from the light source 10 enters the optical device 20 through the light incident surface 23 of the first surface 21 and exits the optical device 20 through the second surface 22.

The optical device 20 may have a structure in which a thickness Tf thereof, from a bottom surface of the optical device 20 to a center of the flange portion 25, corresponds to about ⅓ to about ½ of an overall thickness Tt of the optical device 20.

The first surface 21 may be a surface provided above the light source 10 to face the light source 10 and may correspond to a bottom surface of the optical device 20. A central portion of the first surface 21 through which an optical axis Z passes may be recessed toward the second surface 22, to form a recess portion 24 forming the light incident surface 23. In other words, the first surface 21 is a bottom surface of the optical device 20 and faces the light source 10. The central portion of the first surface 21, which corresponds to the light incident surface 23, may be partially concave and partially convex. Light emitted from the light source 10 enters the optical device 20 through the light incident surface 23. The central portion of the first surface 21 also corresponds to the recess portion 24.

The recess portion 24 may have a rotationally symmetrical structure about the optical axis Z passing through a center of the optical device 20, and a surface of the recess portion 24 may be defined as the light incident surface 23 onto which light emitted from the light source 10 is incident. Thus, light generated by the light source 10 may pass through the light incident surface 23 to enter the interior of the optical device 20.

The recess portion 24 may be formed inwardly in the optical device 20 in a direction inwardly from the first surface 21. In an opening of the recess portion 24, a diameter of an end portion thereof, for example, the size of a transverse cross-section thereof exposed to the first surface 21 may be greater than that of the light source 10. In other words, the recess portion 24 may be a cavity of the optical device 20 and may have a cross-section similar to a mathematical normal distribution (e.g., a Gaussian) line. The recess portion 24 may be disposed above the light source 10. When a circumference of the recess portion 24 is measured along a plane that is substantially perpendicular to the optical axis Z, a first circumference of the recess portion 24, which is proximate to the light source 10, is greater than a second circumference of the recess portion 24, which is distant to the light source 10. The recess portion 24 may be provided above the light source 10 to face the light source 10 and to cover the light source 10.

The light incident surface 23 may include a first curved surface 23a and a second curved surface 23b and may have an inflection point A at a contact point at which the first curved surface 23a and the second curved surface 23b contact each other. The first curved surface 23a may be a concavely curved surface formed by allowing a center thereof through which the optical axis Z passes to be recessed concavely toward the second surface 22. In other words, the first curved surface 23a is concave. The optical axis Z passes through the center of the first curved surface 23a. The second curved surface 23b may be a convexly curved surface extended from an edge of the first curved surface 23a to be connected to the first surface 21.

As illustrated in FIG. 2, a transverse cross-section of the light incident surface 23 may have a bilaterally symmetrical structure with respect to the optical axis Z. For example, the first curved surface 23a and the second curved surface 23b may be symmetrical with respect to the optical axis Z. A vertical cross-sectional shape of a half of the light incident surface 23 may have an “S” shape.

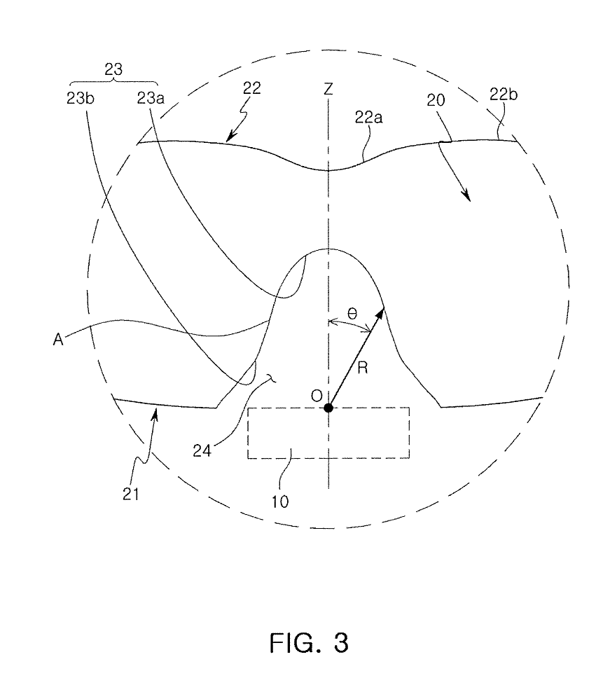

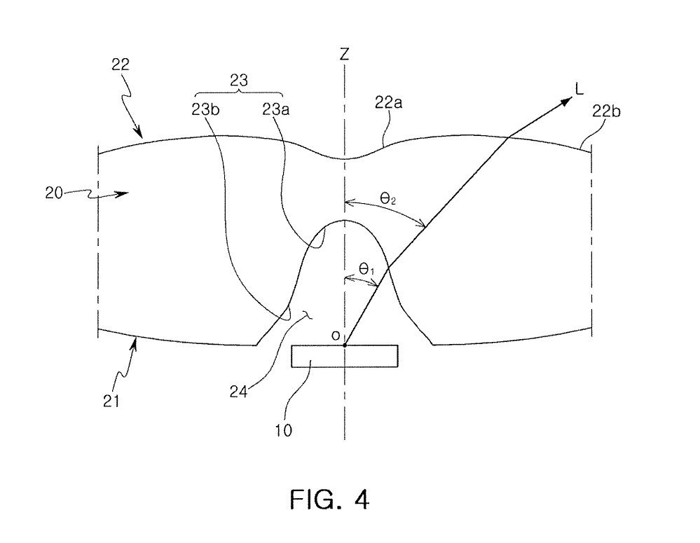

FIGS. 3 and 4 are enlarged views illustrating a portion of the light incident surface 23. FIG. 3 is a cross-sectional view schematically illustrating an enlarged light incident surface 23 of the optical device 20 of FIG. 2, according to an exemplary embodiment of the present inventive concept. FIG. 4 is a cross-sectional view illustrating a relationship between an angle of incidence and a refraction angle of the light incident surface 23 of the optical device 20 of FIG. 3, according to an exemplary embodiment of the present inventive concept.

As illustrated in FIG. 3, a shape of the light incident surface 23 may have a structure satisfying the following conditions 1 to 3.

Condition 1: dR/dθ<0 within a range of 0°≦θ≦55°.

Condition 2: dR/dθ=0 within a range of 55°<θ<65°.

Condition 3: dR/dθ>0 within a range of 65°≦θ.

For example, when an intersection point between the optical axis Z and a light emission surface of the light source 10 is defined as a reference point O, “R” refers to a straight line connecting the reference point O and an arbitrary point of the light incident surface 23 to each other, and “θ” refers to an angle formed by the straight line “R” with respect to the optical axis Z.

Based on the case of θ=0°, a change in a length of “R” may be a negative number as θ increases within a range of about θ≦55° and may be a positive number as θ increases within a range of θ≧65°. In other words, in the range of 0°≦θ≦55°, as θ increases, the length of “R” decreases. Thus, dR/dθ<0 within a range of 0°≦θ≦55°. In the range of 65°≦θ, as θ increases, the length of “R” increases. Thus, dR/dθ>0 within the range of 65°≦θ. In addition, the light incident surface 23 may have a shape in which a change in the length of “R” does not occur within a range of 55°<θ<65°. In other words, within the range of 55°<θ<65°, the length of “R” does not change as θ increases. A gradient of the light incident surface 23 is reversed within the range of 55°<θ<65°.

Further, as illustrated in FIG. 4, a shape of the light incident surface 23 may have a structure satisfying the following conditions 4 to 6 together with the conditions 1 to 3, or the shape of the light incident surface 23 may have a structure satisfying the following conditions 4 to 6 alone.

Condition 4: θ2/θ1>1 within a range of 0°≦θ1≦55°.

Condition 5: θ2/θ1=1 within a range of 55°<θ1<65°.

Condition 6: θ2/θ1<1 within a range of 65°≦θ1.

“θ1” refers to an angle of incidence of light formed by arbitrary light L emitted from the light source 10 and incident on the light incident surface 23, with respect to the optical axis Z, and “θ2” refers a refraction angle of light formed by the light L having the angle of incidence θ1 refracted from the light incident surface 23 toward the second surface 22, with respect to the optical axis Z. In other words, when point O falls along the optical axis Z, the light L emitted from point O has an angle “θ1” with respect to the optical axis Z, and when the light L enters the optical device 20, the light L refracts to have an angle “θ2” with respect to the optical axis Z.

Light from the light source 10 may be spread on the light incident surface 23 within a range of 0°≦θ1≦55°, and be vertically incident on the light incident surface 23 within a range of 55°<θ1<65°. In other words, with the range of 55°<θ1<65°, “θ1” and “θ2” are equal. An optical path of light collected on the light incident surface 23 may be provided within a range of 65°≦θ1. The light incident surface 23 may have a structure having a cross-section that reverses the direction in which light L emitted from the light structure 10 is refracted

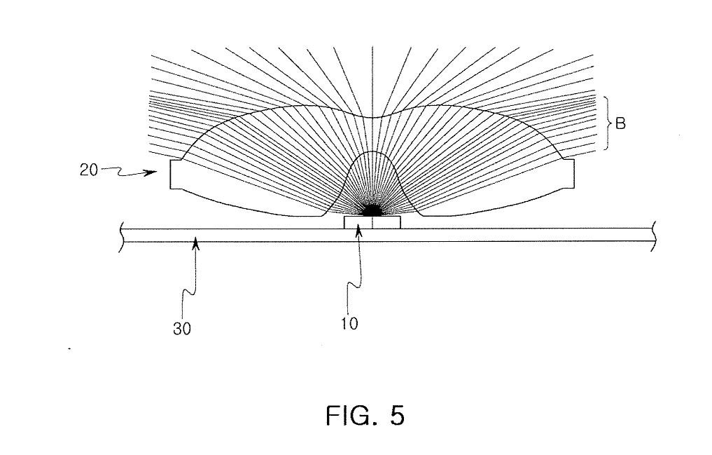

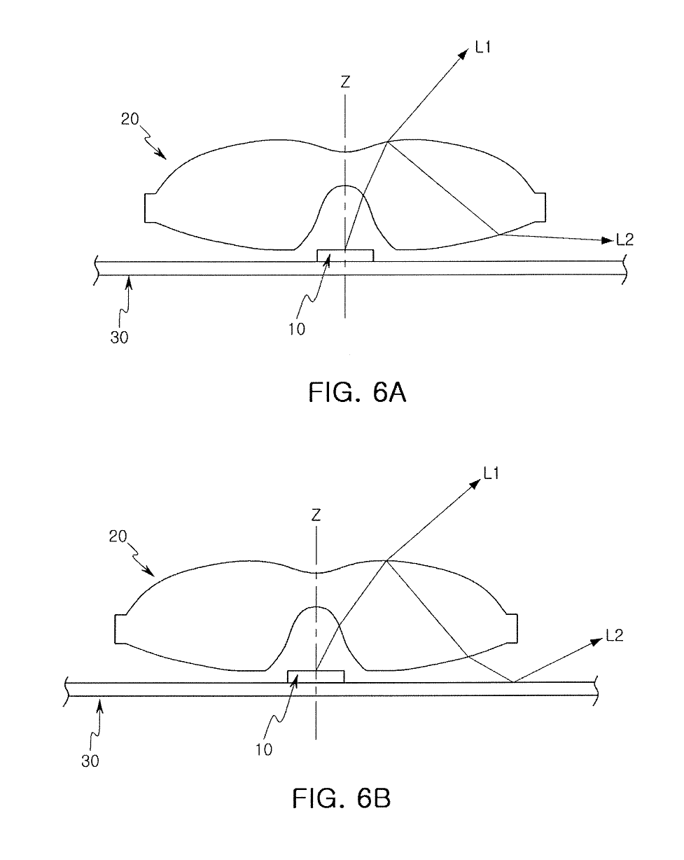

FIGS. 5, 6A and 6B schematically illustrate optical paths in the optical device 20, according to exemplary embodiments of the present inventive concept. FIG. 5 is a cross-sectional view schematically illustrating an optical path of light emitted from the light source 10 of FIG. 2 and passing through the optical device 20 of FIG. 2, according to an exemplary embodiment of the present inventive concept. FIG. 6A is a cross-sectional view schematically illustrating an optical path of light refracted at the first surface 21 of the optical device 20 of FIG. 2 and emitted externally, according to an exemplary embodiment of the present inventive concept. FIG. 6B is a cross-sectional view schematically illustrating an optical path of light refracted at the first surface 21 of the optical device 20 of FIG. 2 and emitted externally, according to an exemplary embodiment of the present inventive concept.

As illustrated in FIG. 5, the light incident surface 23 may be located on a central portion of the first surface 21 corresponding to a bottom surface of the optical device 20, facing the substrate 30 on which the optical device 20 is mounted, according to an exemplary embodiment of the present inventive concept. The light incident surface 23 may have the first curved surface 23a and the second curved surface 23b connected to each other through the inflection point A. A vertical cross-sectional shape of the light incident surface 23 may have an “S” shape. In the case of the light incident surface 23 described above, light emitted from the light source 10 at a small angle with respect to the optical axis Z may be diffused through the light incident surface 23. In addition, an optical path may be provided on which light emitted at a large angle with respect to the optical axis Z is collected inwardly of the optical device 20 in a direction in which a refraction direction of light is reversed once that the light enters the optical device 20. For example, light entering the light incident surface 23 at a first large angle with respect to the optical axis Z is refracted in a first direction once it enters the optical device 20. In addition, light entering the same side of the light incident surface 23 at a second large angle with respect to the optical axis Z is refracted in a second direction which crosses the first direction when the light enters the optical device 20. Thus, unlike a general diffusion lens for only allowing for a uniform diffusion direction, a section B in which a refraction direction of light is reversed may be provided. Thus, a uniformity of brightness distribution in a central region of the optical device 20 is increased.

In addition, as illustrated in FIGS. 6A and 6B, since the first surface 21, which is the bottom surface of the optical device 20, according to an exemplary embodiment of the present inventive concept, has a convex shape in a manner similar to that of the second surface 22 corresponding to a light emission surface, a portion of light, L2, reflected from the second surface 22 of light L1 emitted from the light source 10, may not be reflected a second time from the first surface 21, but is refracted to be directly emitted externally of the optical device 20. Thus, light may be spread across a wide lateral region. In other words, the first surface 21 may also function as a light emission surface, and a distance between the first surface 21 and the substrate 30 on which the optical device 20 is mounted may be secured, such that brightness distribution uniformity in a central portion of the optical device 20 may be increased.

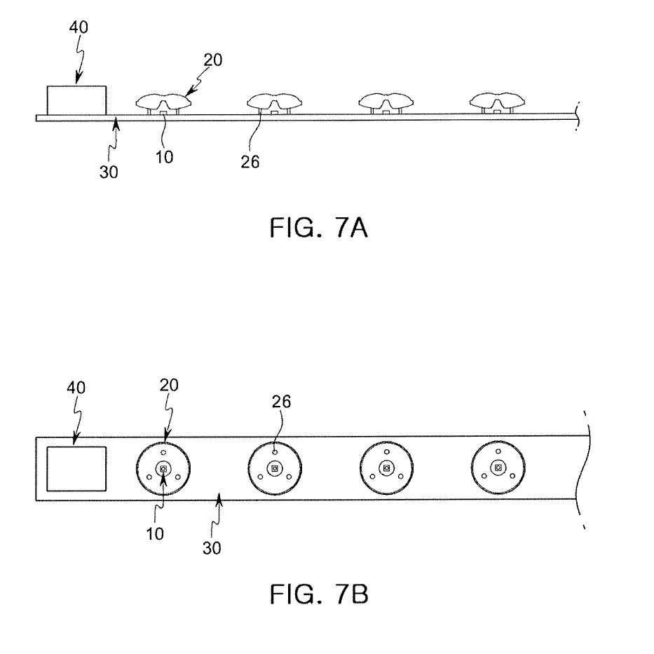

With reference to FIGS. 7A and 7B, the first surface 21 may further include a support portion 26 supporting the optical device 20. The support portion 26 may be provided in plural and the plurality of support portions 26 may be spaced apart from one another along a circumference of the recess portion 24. The optical device 20 may be disposed, for example, on the circuit board 30 through the support portion 26.

The second surface 22 may be disposed to oppose the first surface 21. The second surface 22 may be provided as a light emission surface and correspond to an upper surface of the optical device 20, from which light having entered the interior of the optical device 20 through the light incident surface 23 is externally emitted.

As illustrated in FIG. 2, the second surface 22 may be shaped as a dome and may extend upwardly from an edge of the first surface 21 while having a structure in which a central portion of the structure of the second surface 22 is recessed toward the recess portion 24 at a location through which the optical axis Z passes. Thus, the second surface 22 includes a concave portion at a central portion thereof where the optical axis Z passes through. In other words, with reference to FIG. 2, the second surface 22 may have a concave portion 22a being recessed toward the first surface 21 to have a concavely curved surface, and a convex portion 22b having a convexly curved surface continuously extended from an edge of the concave portion 22a to an outer edge of the optical device 20.

On the second surface 22, a plurality of concave-convex portions 22c may be periodically arranged in a direction from the optical axis Z to the outer edge of the optical device 20. The plurality of concave-convex portions 22c may have a ring shaped structure corresponding to a transverse cross-sectional shape of the optical device 20, and may form concentric circles with respect to the optical axis Z. In addition, the plurality of concave-convex portions 22c may be arranged in a radially diffused form while forming a periodical pattern along a surface of the second surface 22, based on the optical axis Z.

The plurality of concave-convex portions 22c may be spaced apart from one another by a predetermined pitch P to form a pattern. In this case, the pitch P between the plurality of concave-convex portions 22c may be within a range of about 0.01 mm to about 0.04 mm. The plurality of concave-convex portions 22c may compensate for a difference in performance between the optical devices 20 due to minute manufacturing errors that may occur in a process of manufacturing the optical devices 20. Accordingly, uniformity of brightness distribution may be increased.

The optical device 20 may be formed using a resin material having light transmissivity which, for example, may contain polycarbonate (PC), polymethyl methacrylate (PMMA), an acrylic resin, or the like. In addition, the optical device 20 may be formed of glass, but exemplary embodiments of the present inventive concept are not limited thereto.

The optical device 20 may contain a light dispersion material within a range of about 3% to about 15%. The light dispersion material may include, for example, SiO₂, TiO₂ or Al₂O₃. In a case in which the light dispersion material is contained in a content of less than 3%, light may not be sufficiently distributed such that light dispersion effects may not be expected. In addition, in a case in which the light dispersion material is contained in a content of more than 15%, an amount of light emitted outwardly from the optical device 20 may be reduced. Thus, light extraction efficiency may be reduced.

The optical device 20 may be formed using a method of injecting a liquid solvent into a mold to be solidified. For example, an injection molding method, a transfer molding method, a compression molding method, or the like, may be used.

The substrate 30 may be provided as a general flame retardant 4 (FR4) type printed circuit board (PCB) or a flexible PCB, and may be formed using an organic resin material containing epoxy, triagine, silicon rubber, polyimide, or the like, and other organic resin materials. The substrate 30 may also be formed using a ceramic material such as silicon nitride, AlN, Al₂O₃ or the like, or formed using a metal or a metal compound as in a metal-core printed circuit board (MCPCB), a metal copper clad laminate (MCCL), or the like.

FIG. 7A is a cross-sectional view schematically illustrating a light source module, according to an exemplary embodiment of the present inventive concept. FIG. 7B is a plan view schematically illustrating the light source module of FIG. 7A, according to an exemplary embodiment of the present inventive concept. As illustrated in FIGS. 7A and 7B, the substrate 30 may have a rectangular bar type structure having a lengthwise extended form, but exemplary embodiments of the present inventive concept are not limited thereto. The substrate 30 may have a variety of structures corresponding to a structure of a product mounted thereon. For example, the substrate 30 may also have a circular shaped structure.

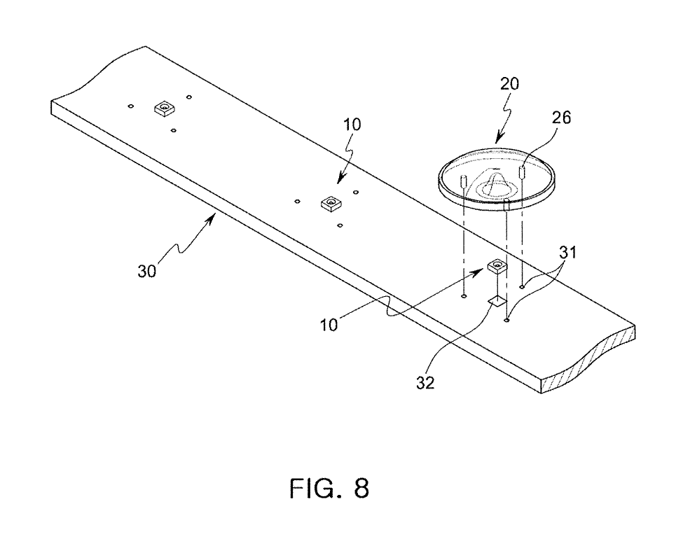

FIG. 8 is a schematic perspective view illustrating a state in which a light source 10 and an optical device 20 are mounted on a substrate 30 of FIG. 7A, according to an exemplary embodiment of the present inventive concept. As illustrated in FIG. 8, fiducial marks 31 and a light source mounting region 32 may be provided on the substrate 30. The fiducial marks 31 and the light source mounting region 32 may respectively demarcate mounting positions of the optical device 20 and the light source 10 on the substrate. For example, a plurality of the fiducial marks 31 may be disposed along a circumference of each light source mounting region 32 on the substrate 30.

The light source 10 may be provided in plurality. The plurality of light sources 10 may be respectively mounted on the light source mounting regions 32, and may be arranged in a lengthwise direction of the substrate 30. In addition, the number of the optical devices 20 may correspond to the number of the light sources 10, and the optical devices 20 may be mounted on the substrate 30 in a structure respectively covering the light sources 10 using the fiducial marks 31 of the respective light source mounting regions 32.

With reference to FIGS. 7A and 7B, a connector 40 for forming a connection between the plurality of light sources 10 and an external power source may be disposed on the substrate 30. The connector 40 may be mounted on an end region of the substrate 30. In addition, a circuit wiring, electrically connected to the light source 10, may be provided on the substrate 30.

As the light source 10, LED chips having a variety of structures or an LED package in which the LED chips are mounted may be used.

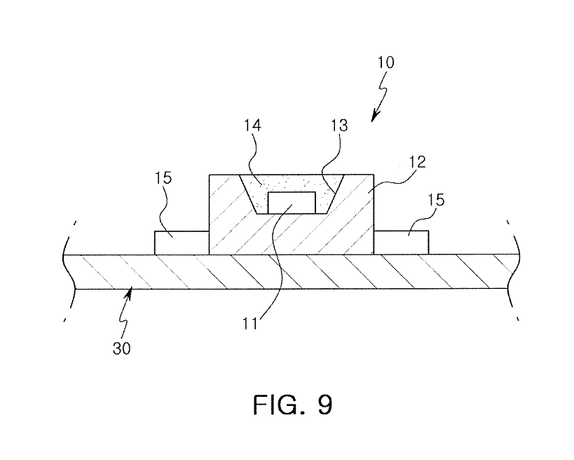

FIG. 9 is a cross-sectional view schematically illustrating a light source, according to an exemplary embodiment of the present inventive concept As illustrated in FIG. 9, the light source 10 may include, for example, a package structure in which an LED chip 11 is mounted within a package body 12 having a reflective cup 13 therein. In addition, the LED chip 11 may be covered by an encapsulation part 14 containing phosphor. In the exemplary embodiment of the present inventive concept, the light source 10 has an LED package form. However, the present inventive concept is not limited thereto.

The package body 12 may be provided as a base member in which the LED chip 11 is mounted on and supported thereby. The package body 12 may be formed using a white molding compound having high light reflectivity. The white molding compound of the package body 12 can increase the amount of light that is emitted externally of the package body 12 by reflecting the light emitted from the LED chip 11. Such a white molding compound may include a thermosetting resin-based material having high heat resistance or a silicon resin-based material. In addition, a white pigment and a filling material, a hardener, a mold release agent, an antioxidant, an adhesion improver, or the like, may be added to the thermoplastic resin-based material. In addition, the package body 12 may also be formed using FR4, composite epoxy materials 3 (CEM-3), an epoxy material, a ceramic material, or the like. The package body 12 may also be formed using a metal such as aluminum (Al).

The package body 12 may include a lead frame 15 for an electrical connection to an external power source. The lead frame 15 may be formed using a material having good electrical conductivity, for example, a metal such as aluminum, copper, or the like. When the package body 12 is formed using a metal, an insulation material may be interposed between the package body 12 and the lead frame 15.

In the case of the reflective cup 13 provided in the package body 12, the lead frame 15 may be exposed to a bottom surface of the reflective cup 13 on which the LED chip 11 is mounted. The LED chip 11 may be electrically connected to the exposed lead frame 15.

The reflective cup 13 may have a structure in which an area of a transverse cross-section of a surface thereof exposed to an upper part of the package body 12 is greater than that of a bottom surface of the reflective cup 13. The surface of the reflective cup 13 exposed to the upper part of the package body 12 may be defined as a light emission surface of the light source 10.

The LED chip 11 may be sealed by the encapsulation part 14 formed in the reflective cup 13 of the package body 12. The encapsulation part 14 may contain a wavelength conversion material.

The wavelength conversion material may include, for example, one or more phosphors which are excited by light generated by the LED chip 11. The excited one or more phosphors emit light having a different wavelength than the wavelength of the light emitted by the LED chip 11. The encapsulation part 14 may also include the wavelength conversion material so that light having various colors as well as white light may be emitted through control of the light emitted by the LED chip 11.

For example, when the LED chip 11 emits blue light, white light may be emitted through a combination of yellow, green, red and/or orange phosphors included in the wavelength conversion material. In addition, an LED chip 11 emitting violet, blue, green, red or infrared light may be included in the light source 10. In this case, the LED chip 11 may perform controlling of the light so that a color rendering index (CRI) of emitted light may be controlled to be within a range of about 40 to about 100. In addition, the LED chip 11 may emit various types of white light having a color temperature of about 2000K to about 20000K. In addition, color may be adjusted to be appropriate for an ambient atmosphere or for people's moods by generating visible violet, blue, green, red or orange light as well as infrared light, as needed. Further, light within a special wavelength band, capable of promoting growth of plants, may also be generated.

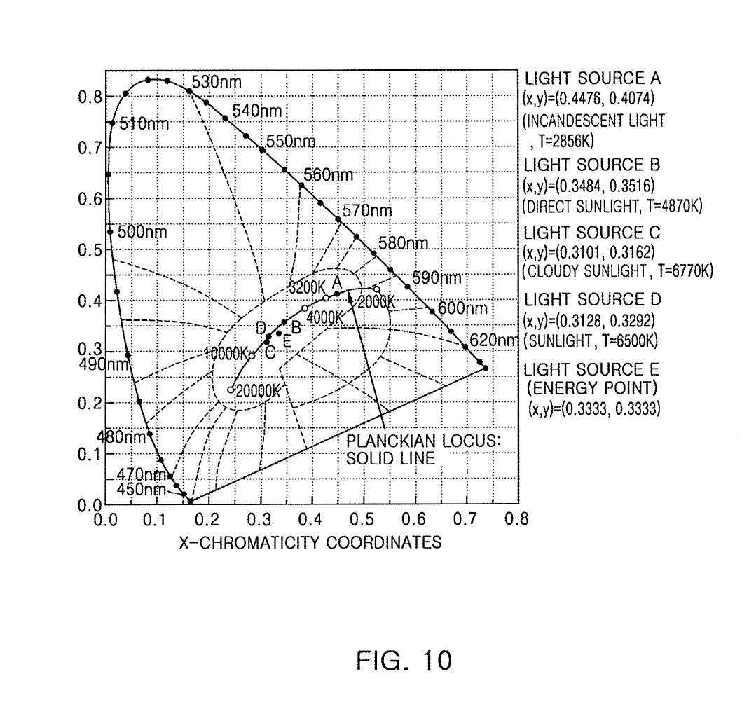

FIG. 10 illustrates a CIE 1931 chromaticity coordinates system for illustrating a wavelength conversion material employable in an exemplary embodiment of the present inventive concept. White light obtained by combining yellow, green, and red phosphors, and/or green, red, and blue LED chips may have two or more peak wavelengths. Referring to FIG. 10, coordinates in format (x, y) including (0.4476, 0.4074), (0.3484, 0.3516), (0.3101, 0.3162), (0.3128, 0.3292), and (0.3333, 0.3333) are located in line segments connected to one another on the CIE 1931 chromaticity coordinates system. Alternatively, the coordinates (x, y) may be located in a region surrounded by the line segments and black body radiation spectrum. A color temperature of the white light may be within a range of about 2000K to about 20000K.

Phosphors may be represented by the following empirical formulae and have a color as described below.

Oxide-based Phosphors: Yellow and green Y₃Al₅O₁₂:Ce, Tb₃Al₅O₁₂:Ce, Lu₃Al₅O₁₂:Ce.

Silicate-based Phosphors: Yellow and green (Ba,Sr)₂SiO₄:Eu, Yellow and yellowish-orange (Ba,Sr)₃SiO₅:Ce.

Nitride-based Phosphors: Green β-SiAlON:Eu, yellow La₃Si₆N₁₁:Ce, yellowish-orange α-SiAlON:Eu, red CaAlSiN₃:Eu, Sr₂Si₅N₈:Eu, SrSiAl₄N₇:Eu, SrLiAl₃N₄:Eu, Ln₄₋ₓ(Eu_{z}M_{1-z})ₓSi_{12-y}Al_{y}O_{3+x+y}N_{18-x-y} (0.5≦x≦3, 0<z<0.3, 0<y≦4) (e.g Ln is a group IIIa element or a rare-earth element, and M is Ca, Ba, Sr or Mg).

Fluoride-based Phosphors: KSF-based red K₂SiF₆:Mn₄₊, K₂TiF₆:Mn₄₊, NaYF₄:Mn₄₊, NaGdF₄:Mn₄₊.

A composition of phosphors should conform to stoichiometry, and respective elements may be substituted with other elements in respective groups of the periodic table of elements. For example, Sr may be substituted with Ba, Ca, Mg, or the like, of an alkaline earth group II, and Y may be substituted with lanthanum-based Tb, Lu, Sc, Gd, or the like. In addition, Eu or the like, an activator, may be substituted with Ce, Tb, Pr, Er, Yb, or the like, according to a required level of energy. Further, an activator alone, or a sub-activator or the like, may be used for modification of characteristics thereof.

In the case of a fluoride-based red phosphor, to increase reliability of the fluoride-based red phosphor under conditions of high temperature and high humidity, phosphors may be coated with a fluoride not containing Mn. In addition, a phosphor surface or a fluoride-coated surface of phosphors that is coated with fluoride not containing Mn may further be coated with an organic material. In the case of the fluoride-based red phosphor as described above, a narrow full width at half maximum of 40 nm or less may be obtained, unlike in the case of other phosphors. The fluoride-based red phosphors may be used in high-resolution television (TV) sets such as ultra-high-definition (UHD) TVs.

In the wavelength conversion material, a material such as a quantum dot (QD) may be used to substitute phosphor. In addition, a mixture of a phosphor and QD may be used in the wavelength conversion material.

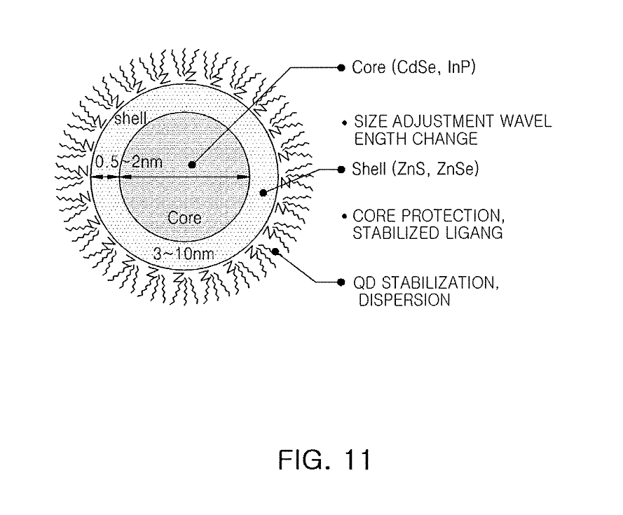

FIG. 11 is a schematic diagram illustrating a cross-sectional structure of a QD, according to an exemplary embodiment of the present inventive concept. The QD may have a core-shell structure using a group III-V or group II-VI compound semiconductor. For example, the QD may have a core formed using CdSe, InP, or the like, and a shell formed using ZnS, ZnSe, or the like. Further, the QD may have a ligand for stabilization of the core and the shell. For example, the core may have a diameter ranging from approximately 1 nm to approximately 30 nm. In an exemplary embodiment of the present inventive concept, the core may have a diameter ranging from approximately 3 nm to approximately 10 nm. The shell may have a thickness ranging from approximately 0.1 nm to approximately 20 nm.

The QD may have various colors depending on the size thereof. In a case in which the QD is used as a phosphor substitute, the Qd may be used as a red or green phosphor. When using the QD, a narrow full width at half maximum of, for example, about 35 nm, may be obtained.

In the exemplary embodiment of the present inventive concept, the wavelength conversion material is included in the encapsulation part 14. However, the present inventive concept is not limited thereto. For example, the wavelength conversion material may be included in a film. The film including the wavelength conversion material may be attached to a surface of the LED chip 11. In this case, the application of the wavelength conversion material having a uniform thickness may be facilitated.

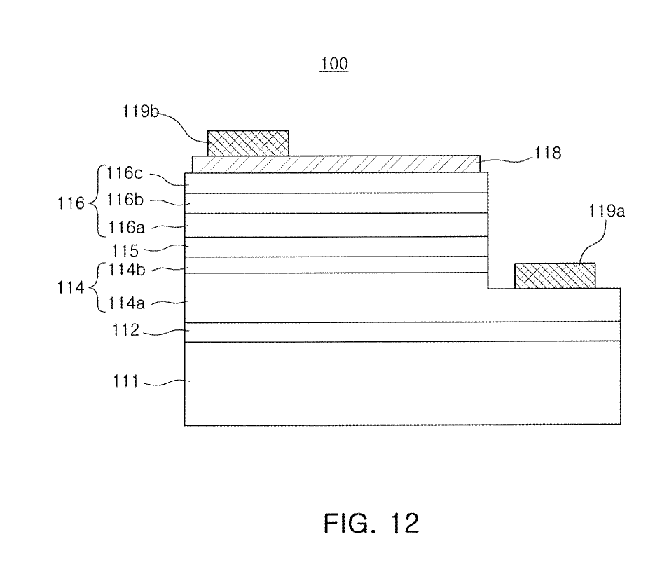

FIG. 12 is a cross-sectional view illustrating an LED chip used as a light source, according to an exemplary embodiment of the present inventive concept. With reference to FIGS. 12 to 15, various LED chips used as light sources will be described, according to exemplary embodiments of the present inventive concept.

With reference to FIG. 12, an LED chip 100 may include a growth substrate 111, a first conductivity-type semiconductor layer 114, an active layer 115, and a second conductivity-type semiconductor layer 116, sequentially stacked on the growth substrate 111. A buffer layer 112 may be disposed between the growth substrate 111 and the first conductivity-type semiconductor layer 114.

The growth substrate 111 may be provided as an insulating substrate such as a sapphire substrate, but the present inventive concept is not limited thereto. In addition, the growth substrate 111 may be provided as a conductive or semiconductor substrate. For example, the growth substrate 111 may be formed using SiC, Si, MgAl₂O₄, MgO, LiAlO₂, LiGaO₂, or GaN as well as sapphire.

The buffer layer 112 may be formed of InₓAl_{y}Ga_{1-x-y}N (0≦x≦1, 0≦y≦1, 0≦x+y≦1). For example, the buffer layer 112 may be formed using GaN, AlN, AlGaN, or InGaN. The buffer layer 112 may be formed by combining a plurality of layers or gradually changing a composition as required.

The first conductivity-type semiconductor layer 114 may be provided as a nitride semiconductor being an n-type semiconductor InₓAl_{y}Ga_{1-x-y}N (0≦x<1, 0≦y<1, 0≦x+y<1), and an n-type impurity of the n-type semiconductor may be silicon (Si). For example, the first conductivity-type semiconductor layer 114 may contain an n-type GaN layer.

According to the exemplary embodiment of the present inventive concept, the first conductivity-type semiconductor layer 114 may include a first conductivity-type semiconductor contact layer 114a and a current diffusion layer 114b. An impurity concentration of the first conductivity-type semiconductor contact layer 114a may be within a range of about 2×10¹⁸ cm⁻³ to about 9×10¹⁹ cm⁻³. A thickness of the first conductivity-type semiconductor contact layer 114a may be within a range of about 1 μm to about 5 μm. The current diffusion layer 114b may have a structure in which a plurality of InₓAl_{y}Ga_{(1-x-y)}N (0≦x, y≦1, 0≦x+y≦1) layers having different compositions or different impurity contents are repeatedly stacked. For example, the current diffusion layer 114b may be an n-type super-lattice layer having a structure in which an n-type GaN layer having a thickness of about 1 nm to about 500 nm and/or two or more layers formed of AlₓIn_{y}Ga_{z}N (0≦x,y,z≦1, except for x=y=z=0) and having different compositions are repeatedly stacked. An impurity concentration of the current diffusion layer 114b may be approximately 2×10¹⁸ cm³ to approximately 9×10¹⁹ cm³. The current diffusion layer 114b may further include an insulation material layer as needed.

The second conductivity-type semiconductor layer 116 may be provided as a nitride semiconductor layer being a p-type semiconductor InₓAl_{y}Ga_{1-x-y}N (0≦x<1, 0≦y<1, 0≦x+y<1), and a p-type impurity of the p-type semiconductor may be Mg. For example, the second conductivity-type semiconductor layer 116 may have a single layer structure, or a multilayer structure having different compositions as illustrated in the exemplary embodiment of the present inventive concept. As illustrated in FIG. 12, the second conductivity-type semiconductor layer 116 may include an electron blocking layer (EBL) 116a, a low concentration p-type GaN layer 116b, and a high concentration p-type GaN layer 116c provided as a contact layer. For example, the EBL 116a may have a structure in which a plurality of InₓAl_{y}Ga_{(1-x-y)}N (0≦x≦1, 0≦y≦1, 0≦x+y≦1) layers having different compositions and having a thickness within a range of about 5 nm to about 100 nm are stacked, or may have a single layer formed of Al_{y}Ga_{(1-y)}N (0<y≦1). An energy band gap of the EBL 116a may be reduced in a direction away from an active layer 115. For example, a composition of A1 of the EBL 116a may be reduced in a direction away from the active layer 115.

The active layer 115 may have a multiple quantum well (MQW) structure in which a quantum well layer and a quantum barrier layer are alternately stacked. For example, the quantum well layer and the quantum barrier layer may be InₓAl_{y}Ga_{1-x-y}N (0≦x≦1, 0≦y≦1, 0≦x+y≦1) layers having different compositions. For example, the quantum well layer may be an InₓGa₁₋ₓN (0<x≦1) layer, and the quantum barrier layer may be a GaN or AlGaN layer. Thicknesses of the quantum well layer and the quantum barrier layer may be respectively within a range of about 1 nm to about 50 nm. The active layer 115 is not limited to an MQW structure, but may have a single quantum well (SQW) structure.

The LED chip 100 may include a first electrode 119a disposed on the first conductivity-type semiconductor layer 114, and an ohmic contact layer 118 and a second electrode 119b sequentially disposed on the second conductivity-type semiconductor layer 116.

The first electrode 119a may contain a material such as Ag, Ni, Al, Cr, Rh, Pd, Ir, Ru, Mg, Zn, Pt, Au, and the like, but the present inventive concept is not limited thereto. The first electrode 119a may be formed in a single layer or in a two or more layer structure. A pad electrode layer may be further provided on the first electrode 119a. The pad electrode layer may be a layer containing Au, Ni, Sn, or the like.

The ohmic contact layer 118 may be implemented in a variety of methods depending on a chip structure. For example, in the case of a flip-chip structure, the ohmic contact layer 118 may contain a metal such as Ag, Au, Al, or the like, and a transparent conductive oxide such as indium tin oxide (ITO), zinc indium oxide (ZIO), gallium indium oxide (GIO), or the like. In the case of an opposite layout structure of the flip-chip structure, the ohmic contact layer 118 may be configured as a light transmitting electrode. The light transmitting electrode may be provided as a transparent conductive oxide layer or nitride layer. For example, the light transmitting electrode may include ITO, zinc-doped indium tin oxide (ZITO), ZIO, GIO, zinc tin oxide (ZTO), fluorine-doped tin oxide (FTO), aluminum-doped zinc oxide (AZO), gallium-doped zinc oxide (GZO), In₄Sn₃O₁₂, or Zn₍₁₋ₓ₎MgₓO (Zinc Magnesium Oxide, 0≦x≦1). The ohmic contact layer 118 may also contain graphene, as necessary. The second electrode 119b may contain Al, Au, Cr, Ni, Ti, or Sn.

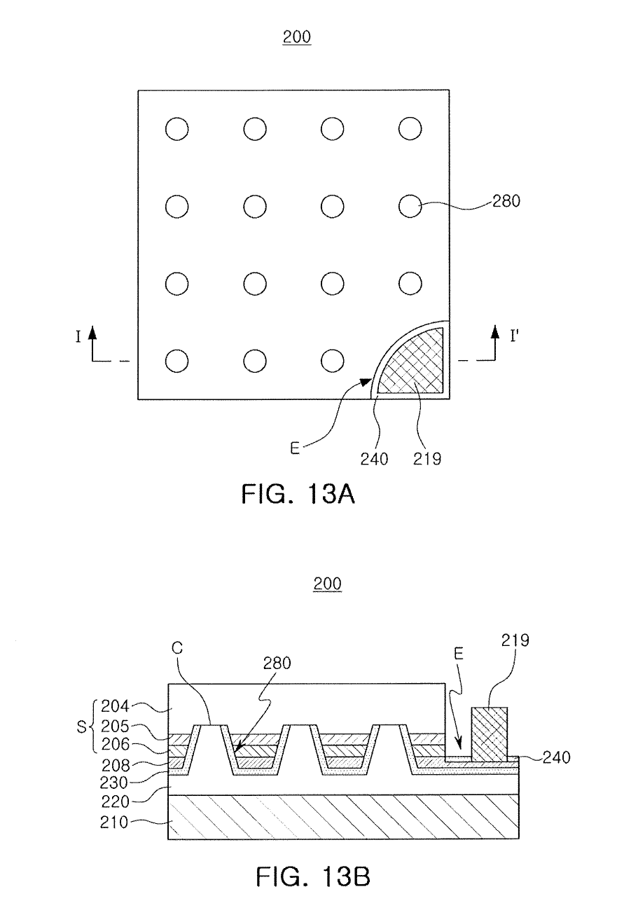

FIG. 13A is a plan view illustrating an LED chip used as a light source, according to an exemplary embodiment of the present inventive concept. FIG. 13B is a side cross-sectional view of the LED chip of FIG. 13A, taken along line I-I′ of FIG. 13A, according to an exemplary embodiment of the present inventive concept.

An LED chip 200 illustrated in FIGS. 13A and 13B may have a large area structure for high output illumination. The LED chip 200 may have a structure for an increase in current dispersion efficiency and heat dissipation efficiency.

The LED chip 200 may include a light emitting laminate S, a first electrode 220, an insulating layer 230, a second electrode 208, and a conductive substrate 210. The light emitting laminate S may include a first conductivity-type semiconductor layer 204, an active layer 205, and a second conductivity-type semiconductor layer 206 stacked sequentially.

The first electrode 220 may include one or more conductive vias 280 electrically insulated from the second conductivity-type semiconductor layer 206 and the active layer 205 and extended to at least a portion of a region of the first conductivity-type semiconductor layer 204 to be electrically connected to the first conductivity-type semiconductor layer 204. The conductive vias 280 may be extended from an interface of the first electrode 220 to an interior of the first conductivity-type semiconductor layer 204 while penetrating through the second electrode 208, the second conductivity-type semiconductor layer 206, and the active layer 205. The conductive vias 280 may be formed through an etching process, for example, inductively coupled plasma reactive ion etching (ICP-RIE), or the like.

On the first electrode 220, the insulating layer 230 for electrically insulating regions except for the conductive substrate 210 and the first conductivity-type semiconductor layer 204 from the first electrode 220 may be provided. As illustrated in FIG. 13B, the insulating layer 230 may be formed on side surfaces of the conductive vias 280 as well as between the second electrode 208 and the first electrode 220. Thus, the second electrode 208, the second conductivity-type semiconductor layer 206, and the active layer 205 exposed to the side surfaces of the conductive vias 280 may be insulated from the first electrode 220. The insulating layer 230 may be formed by depositing an insulation material such as SiO₂, SiOₓN_{y}, or SiₓN_{y}.

A contact region C of the first conductivity-type semiconductor layer 204 may be exposed through the conductive vias 280, and a portion of the first electrode 220 may contact the contact region C through the conductive vias 280. Thus, the first electrode 220 may be connected to the first conductivity-type semiconductor layer 204.

The number, shape, or pitch of the conductive vias 280, or a contact diameter or a contact area of the conductive vias 280 with the first and second conductivity-type semiconductor layers 204 and 206, may be designed to reduce contact resistance. The conductive vias 280 may be formed to be arranged in rows and columns in various forms to increase current flow. A contact area and the number of the conductive vias 280 may be adjusted such that the area of the contact region C may be within a range of about 0.1% to about 20% of a planar area of the light emitting laminate S. According to an exemplary embodiment of the present inventive concept, the area of the contact region C may be within a range of about 0.5% to about 15% of a planar area of the light emitting laminate S. According to an exemplary embodiment of the present inventive concept, the area of the contact region C may be within a range of about 1% to about 10% of the planar area of the light emitting laminate S. In a case in which the area of the contact region C is smaller than 0.1% of a planar area of the light emitting laminate S, current dispersion may not be uniform. Thus light emission characteristics of the LED chip 200 may be reduced. In a case in which the area of the contact region C is 20% or more of the planar area of the light emitting laminate S, light emission characteristics and brightness of the light emitted from the LED chip 200 may be reduced since a light emission area of the light emitting laminate S is small.

A radius of the conductive vias 280 in a contact region thereof with the first conductivity-type semiconductor layer 204 may be within a range of, for example, about 1 μm to about 50 μm, and the number of the conductive vias 280 may be 1 to 48000 for each light emitting laminate S region, depending on an area of the light emitting laminate S region. Although the number of the conductive vias 280 is changed according to the area of the light emitting laminate S region, for example, 2 to 45000 conductive vias 280 may be disposed in a light emitting laminate S region. In an exemplary embodiment of the present inventive concept, 5 to 40000 conductive vias 280 may be disposed in a light emitting laminate S region. In an exemplary embodiment of the present inventive concept, 10 to 35000 conductive vias 280 may be disposed in a light emitting laminate S region. A distance between the conductive vias 280 may be within a range of about 10 μm to about 1000 μm in a matrix structure having rows and columns. In an exemplary embodiment of the present inventive concept, a distance between the conductive vias 280 may be within a range of about 50 μm to about 700 μm. In an exemplary embodiment of the present inventive concept, a distance between conductive vias 280 may be within a range of about 100 μm to about 500 μm. In an exemplary embodiment of the present inventive concept, a distance between conductive vias 280 may be within a range of 150 μm to 400 μm.

In a case in which a distance between the conductive vias 280 is less than 10 μm, the number of conductive vias 280 per unit area of the light emitting laminate S may increase, and a light emission area of the light emitting laminate S may be reduced. Thus, light emission efficiency of the LED chip 200 may be reduced. In a case in which a distance between the conductive vias 280 is greater than 1000 μm, current may not be evenly diffused. Thus light emission efficiency of the LED chip 200 may be reduced. A depth of the conductive vias 280 may be changed depending on thicknesses of the second conductivity-type semiconductor layer 206 and the active layer 205, and for example, the depth of the conductive vias 280 may be within a range of about 0.1 μm to about 5.0 μm.

The second electrode 208 may provide an electrode formation region E extended outwardly of the light emitting laminate S to be exposed externally as illustrated in FIG. 13B. The electrode formation region E may include an electrode pad portion 219 connecting the second electrode 208 to an external power source. Although the electrode formation region E has been illustrated as being a single region, a plurality of electrode formation regions E may be provided in the second electrode 208 as needed. The electrode formation region E may be formed in a corner of the LED chip 200 to increase a light emission area as illustrated in FIG. 13A.

In the exemplary embodiment of the present inventive concept, an etching stop insulating layer 240 may be disposed around an electrode pad portion 219. The etching stop insulating layer 240 may be formed in the electrode formation region E after the light emitting laminate S is formed and before the second electrode 208 is formed, and may serve as an etching stop portion at the time of performing an etching process to form the electrode formation region E.

The second electrode 208 may include a material having a high level of reflectivity. The second electrode 208 may form an ohmic contact with the second conductivity-type semiconductor layer 206. The second electrode 208 may include the reflective material included in the second electrode 208.

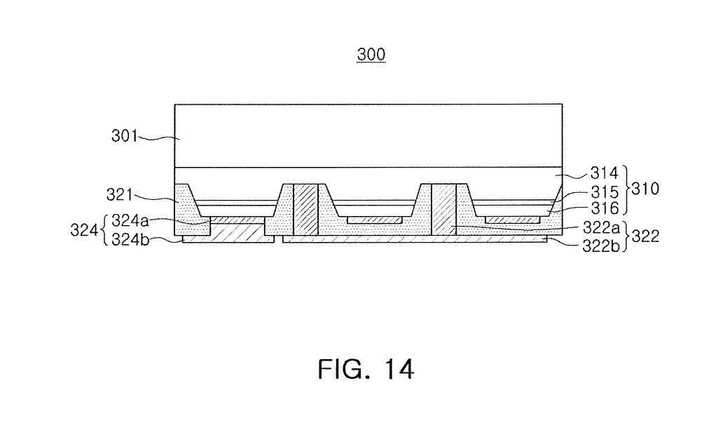

FIG. 14 is a side cross-sectional view illustrating an LED chip used as a light source, according to an exemplary embodiment of the present inventive concept.

With reference to FIG. 14, an LED chip 300 may include a semiconductor laminate 310 formed on a substrate 301. The semiconductor laminate 310 may include a first conductivity-type semiconductor layer 314, an active layer 315, and a second conductivity-type semiconductor layer 316.

The LED chip 300 may include first and second electrodes 322 and 324 respectively connected to the first and second conductivity-type semiconductor layers 314 and 316. The first electrode 322 may include connection electrode portions 322a that may be conductive vias penetrating the second conductivity-type semiconductor layer 316 and the active layer 315 to be connected to the first conductivity-type semiconductor layer 314, and a first electrode pad 322b connected to the connection electrode portions 322a. The connection electrode portions 322a may be surrounded by an insulating portion 321 to be electrically isolated from the active layer 315 and the second conductivity-type semiconductor layer 316. In the LED chip 300, the connection electrode portions 322a may be formed in a region in which the semiconductor laminate 310 has been etched. The number, a shape, or a pitch of the connection electrode portions 322a, or a contact area thereof with the first conductivity-type semiconductor layer 314 may be designed to reduce contact resistance. In addition, the connection electrode portions 322a may be arranged so that rows and columns thereof may be formed on the semiconductor laminate 310, thereby increasing current flow. The second electrode 324 may include an ohmic contact layer 324a formed on the second conductivity-type semiconductor layer 316, and a second electrode pad 324b.

The connection electrode portions and the ohmic contact layers 322a and 324a may respectively have a structure in which a conductive material having an ohmic characteristic with the first and second conductivity-type semiconductor layers 314 and 316 is formed in a single layer or a multilayer structure. For example, the connection electrode portions and the ohmic contact layers 322a and 324a may be formed in a process of depositing or sputtering one or more materials such as Ag, Al, Ni, Cr, a transparent conductive oxide (TCO), and the like.

The first and second electrode pads 322b and 324b may be connected to the connection electrode portions and the ohmic contact layers 322a and 324a, respectively, so as to function as external terminals of the LED chip 300. For example, the first and second electrode pads 322b and 324b may be formed using Au, Ag, Al, Ti, W, Cu, Sn, Ni, Pt, Cr, NiSn, TiW, AuSn, or a eutectic metal thereof.

The first and second electrodes 322 and 324 may be disposed in a single direction and mounted on a lead frame, or the like, in a flip-chip form.

The first and second electrodes 322 and 324 may be electrically isolated from each other by the insulating portion 321. In an exemplary embodiment of the present inventive concept, the insulating portion 321 may include any material having an electrical insulation property. In an exemplary embodiment of the present inventive concept, the insulating portion 321 may include a material having a low light absorption rate. For example, the insulating portion 321 may include a silicon oxide and a silicon nitride such as SiO₂, SiOₓN_{y}, SiₓN_{y}, or the like. The insulating portion 321 may have a light reflective structure formed by dispersing a light reflective filler in a light transmitting material as needed. In addition, the insulating portion 321 may have a multilayer reflective structure in which a plurality of insulating films having different refractive indices are alternately stacked. For example, the multilayer reflective structure may be implemented by a distributed Bragg reflector in which a first insulating film having a first refractive index and a second insulating film having a second refractive index are alternately stacked.

In an exemplary embodiment of the present inventive concept, the multilayer reflective structure may include 2 to 100 insulating films having different refractive indices stacked on each other. In an exemplary embodiment of the present inventive concept, the multilayer reflective structure may include 3 to 70 insulating films having different refractive indices stacked on each other. In an exemplary embodiment of the present inventive concept, the multilayer reflective structure may include 4 to 50 insulating films having different refractive indices stacked on each other. The plurality of insulating films having the multilayer reflective structure may be respectively formed using oxide or nitride such as SiO₂, SiN, SiOₓN_{y}, TiO₂, Si₃N₄, Al₂O₃, TiN, AlN, ZrO₂, TiAlN, TiSiN, or the like, or through a combination thereof. For example, when a wavelength of light generated by the active layer is defined as “k” and “n” is defined as a refractive index of a corresponding layer, the first and second insulating films may be formed to have a thickness of λ/4n, and may have a thickness of approximately 300 Å to 900 Å. In this case, a refractive index and a thickness of the first and second insulating films may be designed such that the multilayer reflective structure may have a high degree of reflectivity (e.g., 95% or higher) with respect to a wavelength of light generated by the active layer 315.

The refractive index of the first insulating film and refractive index of the second insulating film may respectively be in a range of around 1.4 to around 2.5, and may respectively have values less than refractive indices of the first conductivity-type semiconductor layer 314 and the substrate 301. In addition, the refractive index of the first insulating film and refractive index of the second insulating film may respectively have values less than the refractive index of the first conductivity-type semiconductor layer 314 but greater than the refractive index of the substrate 301.

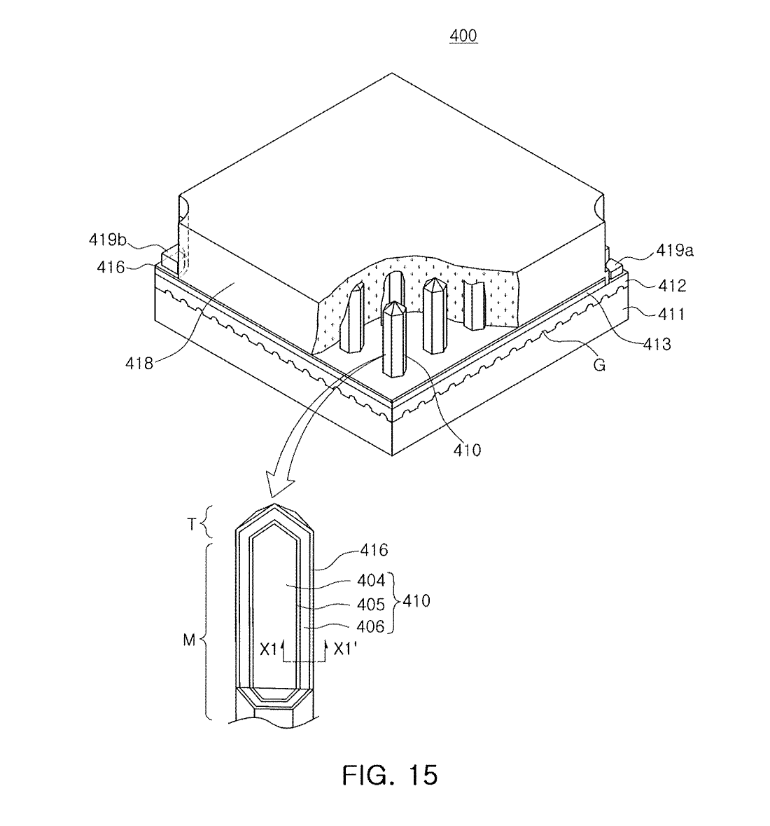

FIG. 15 is a schematic perspective view and a cross-sectional view illustrating an LED chip, according to an exemplary embodiment of the present inventive concept.

With reference to FIG. 15, an LED chip 400 may include a base layer 412 formed of a first conductivity-type semiconductor material and a plurality of light emitting nanostructures 410 disposed thereon.

The LED chip 400 may include a substrate 411 having an upper surface on which the base layer 412 is disposed. Concave-convex portions G may be formed on the upper surface of the substrate 411. The concave-convex portions G may increase the quality of a grown single crystal as well as increase light extraction efficiency. The substrate 411 may be provided as an insulating substrate, a conductive substrate, or a semiconductor substrate. For example, the substrate 411 may be formed using sapphire, SiC, Si, MgAl₂O₄, MgO, LiAlO₂, LiGaO₂, or GaN.

The base layer 412 may include a first conductivity-type nitride semiconductor layer and may provide a growth surface of the light emitting nanostructure 410. The base layer 412 may be provided as a nitride semiconductor satisfying InₓAl_{y}Ga_{1-x-y}N (0≦x<1, 0≦y<1, 0≦x+y<1) and may be doped with an n-type impurity such as Si. For example, the base layer 412 may be formed using n-type GaN.

An insulating film 413 having openings for growth of the light emitting nanostructures 410. Nanocores 404 of the light emitting nanostructures 410 may be formed on the base layer 412. The nanocores 404 may be formed on a region of the base layer 412 exposed through the openings of insulating film 413. The insulating film 413 may be used as a mask allowing for the growth of the nanocores 404. For example, the insulating film 413 may be formed of an insulation material such as SiO₂ or SiNₓ.

The light emitting nanostructure 410 may include a main portion M having a hexagonal prism shaped structure and an upper end portion T disposed on the main portion M. The main portion M of the light emitting nanostructure 410 may have lateral surfaces having the same crystalline surface, and the upper end portion T of the light emitting nanostructure 410 may have a crystalline surface different from those of the lateral surfaces of the main portion M of the light emitting nanostructure 410. The upper end portion T of the light emitting nanostructure 410 may have a hexagonal pyramid shape. Such a structural shape may be determined by the nanocore 404. The nanocore 404 may also be divided into the main portion M and the upper end portion T.

The light emitting nano structure 410 may include the nanocore 404 configured as a first conductivity-type nitride semiconductor. An active layer 405 and a second conductivity-type nitride semiconductor layer 406 sequentially disposed on a surface of the nanocore 404.

The LED chip 400 may include a contact electrode 416 connected to the second conductivity-type nitride semiconductor layer 406. The contact electrode 416 employed in the exemplary embodiment of the present inventive concept may be formed using a conductive material having light transmission properties. The contact electrode 416 may cause the light emitting nanostructures 410 to emit light, for example, in a direction opposite to the substrate. The contact electrode 416 may include a transparent conductive oxide layer or a nitride layer. For example, the contact electrode 416 may be formed using ITO, ZITO, ZIO, GIO, ZTO, FTO, AZO, GZO, In₄Sn₃O₁₂, or Zn₍₁₋ₓ₎MgₓO (Zinc Magnesium Oxide, 0≦x≦1). In addition, the contact electrode 416 may contain graphene, as needed.

The contact electrode 416 is not limited to a light transmitting material. The contact electrode 416 may include a reflective electrode structure, as needed. For example, the contact electrode 416 may contain a material such as Ag, Ni, Al, Rh, Pd, Ir, Ru, Mg, Zn, Pt, Au, or the like, and may employ a two or more layer structure such as Ni/Ag, Zn/Ag, Ni/Al, Zn/Al, Pd/Ag, Pd/Al, Ir/Ag, Ir/Au, Pt/Ag, Pt/Al, Ni/Ag/Pt, or the like. A flip-chip structure may be implemented by employing the reflective electrode structure as described above.

An insulating protective layer 418 may be formed on the light emitting nanostructures 410. The insulating protective layer 418 may be a passivation portion protecting the light emitting nanostructures 410. In addition, the insulating protective layer 418 may be formed of a material having light transmission properties so that light generated in the light emitting nanostructures 410 may be extracted. In this case, the insulating protective layer 418 may be formed by selectively using a material having appropriate refractivity to increase light extraction efficiency.

In the exemplary embodiment of the present inventive concept, after the contact electrode 416 is formed, the insulating protective layer 418 may fill a space between the plurality of light emitting nanostructures 410. As a material of the insulating protective layer 418, an insulation material such as SiO₂ or SiNₓ may be used. The insulating protective layer 418 may include a material such as TetraEthylOrthoSilane (TEOS), BoroPhospho Silicate Glass (BPSG), CVD-SiO₂, Spin-on Glass (SOG), or Spin-on Dielectric (SOD).

The insulating protective layer 418 may be used to fill a space between the light emitting nanostructures 410, but the present inventive concept is not limited thereto. For example, a space between the light emitting nanostructures 410 may also be filled with an electrode element such as an element of the contact electrode 416. In addition, the space between the light emitting nanostructures 410 may be filled with a reflective electrode material described above.

The LED chip 400 may include first and second electrodes 419a and 419b. The first electrode 419a may be disposed in a portion of a partially exposed region of the base layer 412. The base layer 412 includes a first conductivity-type semiconductor. The second electrode 419b may be disposed in an exposed region of the contact electrode 416. The arrangement of the first and second electrodes 419a and 419b is not limited to the illustration above described with reference to FIG. 15. The first and second electrodes 419a and 419b may be variously arranged depending on the use of the LED chip 400.

The LED chip 400 may have a core-shell nanostructure, and may have low heat generation due to a low combination density, and may have an increased light emission area through the nanostructure to thus increase light emission efficiency. In addition, since the LED chip 400 may include a non-polar active layer, a reduction in light emission efficiency due to polarization may be prevented, and droop may be controlled.

In addition, the plurality of the light emitting nanostructures 410 may emit light having two or more different wavelengths by having a mask layer with a plurality of open regions having different diameters, different intervals (e.g., pitches) between the plurality of open regions of the mask layer, or a different doping concentration or a different indium (In) content mixed in the active layer 405 of the light emitting nanostructure. Thus, white light may be obtained even without using a phosphor in a single light emitting device by controlling light having different wavelengths. In addition, light having desired various colors or white light having different color temperatures may be obtained by combining the lighting device with a different LED chip or with a wavelength conversion material such as a phosphor.

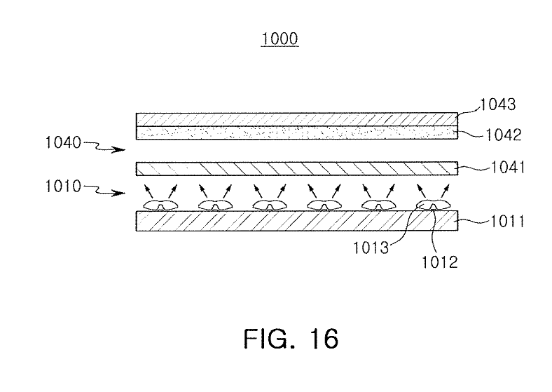

Hereinafter, a lighting device in which a light source module is employed will be described with reference to FIGS. 16 to 18, according to various exemplary embodiments of the present inventive concept.

FIG. 16 is a schematic cross-sectional view of a lighting device, according to an exemplary embodiment of the present inventive concept. With reference to FIG. 16, a lighting device 1000 may have a surface light source type structure, for example, and may be provided as a direct-type backlight unit.

The lighting device 1000 may include an optical sheet 1040 and a light source module 1010 arranged below the optical sheet 1040.

The optical sheet 1040 may include a light diffusion sheet 1041, a prism sheet 1042, and a protective sheet 1043.

The light source module 1010 may include a PCB 1011, a plurality of light sources 1012 mounted on an upper surface of the PCB 1011, and a plurality of optical devices 1013 respectively disposed above the plurality of light sources 1012. The light source module 1010, according to the exemplary embodiment of the present inventive concept, may have a structure similar to that of the light source module 1 of FIG. 1. The plurality of optical devices 1013 may have a biconvex lens structure. Since a vertical cross section of a light incident surface has an “S” shape, uniformity of brightness distribution on a central portion of the optical devices 1013 may be increased. A detailed description of the respective constituent elements of the light source module 1010 can be understood with reference to the foregoing exemplary embodiments of the present inventive concept, for example, with reference to the exemplary embodiment of the present inventive concept described with reference to FIG. 7.

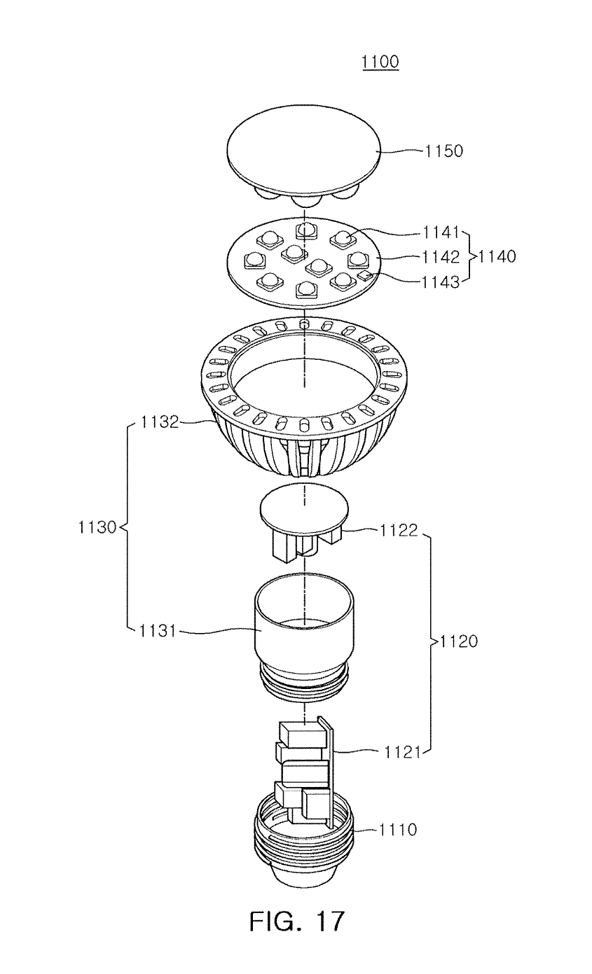

FIG. 17 is a schematic exploded perspective view of a bulb-type lighting device, according to an exemplary embodiment of the present inventive concept.

A lighting device 1100 may include a socket 1110, a power supply unit 1120, a heat radiating unit 1130, a light source module 1140, and an optical unit 1150.

According to an exemplary embodiment of the present inventive concept, the light source module 1140 may include a light emitting device array, and the power supply unit 1120 may include a light emitting device driving unit.

The socket 1110 may be configured such that it may be mounted on an existing lighting apparatus. Power supplied to the lighting device 1100 may be applied through the socket 1110. As illustrated, the power supply unit 1120 may include a first power supply portion 1121 and a second power supply portion 1122 separated from and coupled to each other. The heat radiating unit 1130 may include an internal heat radiating portion 1131 and an external heat radiating portion 1132. The internal heat radiating portion 1131 may be directly connected to the light source module 1140 and/or to the power supply unit 1120. Heat may be transferred to the external heat radiating portion 1132 by the internal heat radiating portion 1131. The optical unit 1150 may include an internal optical portion and an external optical portion, and may be configured such that light emitted from the light source module 1140 may be uniformly dispersed.

The light source module 1140 may receive power from the power supply unit 1120 and emit light to the optical unit 1150. The light source module 1140 may include one or more light sources 1141 having an optical device, a circuit board 1142, and a controller 1143. The controller 1143 may store driving information of the light sources 1141 therein.

The light source module 1140, according to the exemplary embodiment of the present inventive concept, may have a structure similar to that of the light source module 1 of FIG. 1. The optical devices respectively disposed on the light sources 1141 may have a biconvex lens structure. Since a vertical cross section of a light incident surface of the optical devices has an “S” shape, uniformity of brightness distribution on a central portion thereof may be increased. A detailed description of the respective constituent elements of the light source module 1140 can be understood with reference to the foregoing exemplary embodiments of the present inventive concept, for example, with reference to the exemplary embodiment of the present inventive concept with reference to FIG. 7.

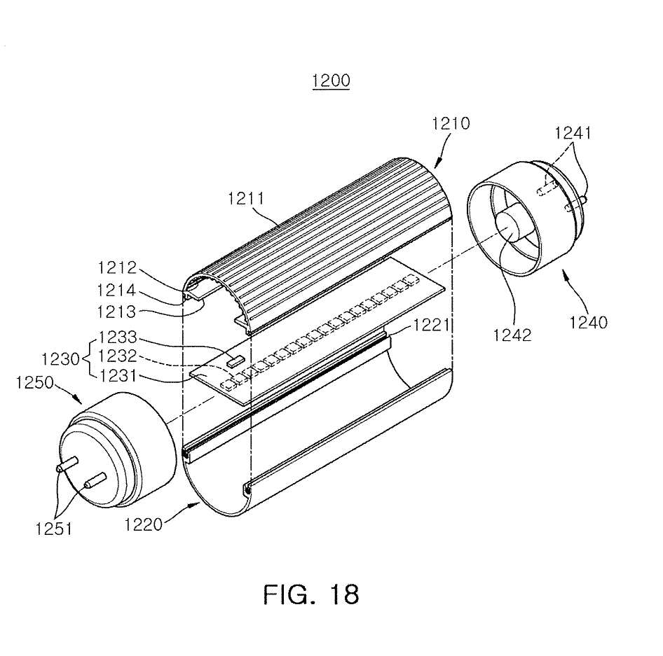

FIG. 18 is a schematic exploded perspective view of a bar type lighting device, according to an exemplary embodiment of the present inventive concept.

A lighting device 1200 may include a heat radiating member 1210, a cover 1220, a light source module 1230, a first socket 1240, and a second socket 1250. A plurality of heat radiating fins 1211 and 1212 having a concave-convex surface shape may be formed on an inner surface or/and an external surface of the heat radiating member 1210. The heat radiating fins 1211 and 1212 may be designed to have various forms and intervals therebetween. A support portion 1213 having a protruding form may be formed inwardly of the heat radiating member 1210. The light source module 1230 may be fixed to the support portion 1213. A stop protrusion 1214 may be formed on both ends of the heat radiating member 1210.

The cover 1220 may include a stop groove 1221 formed therein. The stop groove 1221 may be coupled to the stop protrusion 1214 of the heat radiating member 1210 in a hook coupling structure. The positions in which the stop groove 1221 and the stop protrusion 1214 are formed may be changed inversely.

The light source module 1230 may include a light source array. The light source module 1230 may include a PCB 1231, a light source 1232 having an optical device, and a controller 1233. In an exemplary embodiment of the present inventive concept, the light source module 1230 includes a plurality of light source 1232. Each of the light sources 1232 includes an optical device disposed thereon. As described above, the controller 1233 may store driving information of the light sources 1232 therein. The PCB 1231 may include circuit wirings formed therein for operating the light sources 1232. In addition, constituent elements for operating the light sources 1232 may be provided. The light source module 1230, according to the exemplary embodiment of the present inventive concept, may be substantially identical to the light source module of FIG. 1. Thus, a detailed description thereof may be omitted.

The first and second sockets 1240 and 1250 may be provided as a pair of sockets and may have a structure in which they are coupled to both ends of a cylindrical cover unit. The cylindrical cover unit includes the heat radiating member 1210 and the cover 1220. The first socket 1240 may include electrode terminals 1241 and a power supply device 1242. The second socket 1250 may include dummy terminals 1251 disposed thereon. In addition, an optical sensor and/or a communications module may be disposed on the interior one of the first socket 1240 or the second socket 1250. For example, the optical sensor and/or the communications module may be installed in the second socket 1250 in which the dummy terminals 1251 are disposed. In another example, an optical sensor and/or a communications module may be installed in the first socket 1240 in which the dummy electrode terminals 1241 are disposed.

A lighting device using a light emitting device may be classified as an indoor LED lighting device and as an outdoor LED lighting device. The indoor LED lighting device may mainly be used in a bulb-type lamp, an LED-tube lamp, or a flat-type lighting device, as an existing lighting device retrofit. The outdoor LED lighting device may be used in a streetlight, a safety lighting fixture, a light transmitting lamp, a landscape lamp, a traffic light, or the like.

In addition, a lighting device using LEDs may be utilized as internal and external light sources in vehicles. When used as the internal light source, the lighting device using LEDs may be used as interior lights for motor vehicles, reading lamps, various types of light source for an instrument panel, and the like. When used as the external light sources in vehicles, the lighting device using LEDs may be used in all types of light sources such as headlights, brake lights, turn signal lights, fog lights, running lights for vehicles, and the like.

Further, an LED driving device may be used as a light source in robots or in various kinds of mechanical equipment. An LED lighting device using light within a certain wavelength band may promote the growth of a plant, may change people's moods, or may also be used therapeutically, as emotional lighting.

According to exemplary embodiments of the present inventive concept, an optical device including a light source module may uniformly distribute brightness and may prevent the occurrence of Mura defects.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. An optical device comprising:
a first surface including a light incident surface onto which light is incident; and
a second surface which emits light passing through the light incident surface,
wherein the light incident surface includes a first curved surface and a second curved surface, the first curved surface being disposed in a recess in a central portion of the light incident surface and recessed toward the second surface, the second curved surface being connected to the first curved surface in the recess and extended from the recess, and the first and second curved surfaces have an inflection point at a contact point at which the first and second curved surfaces contact each other, and
wherein the second surface opposes the first surface, and the first and second surfaces form a biconvex lens structure.

2. The optical device of claim 1, wherein an optical axis passes through the recess.

3. The optical device of claim 1, wherein a shape of the light incident surface satisfies conditions 1 to 3:
Condition 1: dR/dθ<0 for θ≦55°
Condition 2: dR/dθ=0 for 55°<θ<65°
Condition 3: dR/dθ>0 for 65°≦θ,
where, when an intersection point between an optical axis passing through the recess and a light emission surface of a light source is a reference point “O”, “R” refers to a straight line connecting the reference point “O” and a point of the light incident surface to each other, and “θ” refers to an angle formed by the straight line “R” with respect to the optical axis.

4. The optical device of claim 3, wherein the shape of the light incident surface satisfies conditions 4 to 6:
Condition 4: θ2/θ1>1 for θ1≦55°
Condition 5: θ2/θ1=1 for 55°<θ1<65°
Condition 6: θ2/θ1<1 for 65°≦θ1,
where “θ1” refers to a light emission angle formed by light emitted from the light source with respect to the optical axis, and “θ2” refers to a refraction angle of the light having the light emission angle “θ1”, which is refracted from the light incident surface toward the second surface, with respect to the optical axis.

5. The optical device of claim 1, further comprising a flange portion disposed between the first surface and the second surface at an edge of the optical device, and
a thickness “Tf” of the optical device measured from a bottom surface of the optical device to a center of the flange portion in a vertical direction corresponds to ⅓ to ½ of an overall thickness “Tt” of the optical device.

6. The optical device of claim 1, wherein, when an intersection point between an optical axis passing through the recess and a light emission surface of a light source is a reference point “O”, a first ray of light emitted from “O” and having a first angle with respect to the optical axis is refracted downward by the light incident surface, and a second ray of light emitted from “O” and having a second angle with respect to the optical axis is refracted upward by the light incident surface,
wherein the first angle is smaller than the second angle.

7. The optical device of claim 1, wherein the second surface comprises a concave portion recessed toward the recess of the first surface, and a convex portion extended from an edge of the concave portion to an edge of the optical device.

8. The optical device of claim 1, further comprising a support portion disposed on the first surface.

9. An optical device comprising:
a first surface including a recess disposed in a central portion of the first surface; and
a second surface that faces the first surface to form a biconvex lens,
wherein the recess is recessed toward the second surface and includes a light incident surface onto which light is incident,
the light incident surface includes a first curved surface and a second curved surface, the first curved surface being disposed in the recess in the central portion of the first surface and recessed toward the second surface, the second curved surface being connected to the first curved surface in the recess and extended from the recess, and the first and second curved surfaces have an inflection point at a contact point at which the first and second curved surfaces contact each other.

10. The optical device of claim 9, wherein a sidewall of the recess has an approximate S-shaped vertical cross-section.

11. A light source module comprising:
a light source; and
an optical device including a first surface and a second surface,
wherein the first surface is disposed above the light source and includes a recess formed in a central portion of the first surface and recessed toward the second surface, and the second surface opposes the first surface to form a biconvex lens,
wherein the recess includes a light incident surface onto which light from the light source is incident,
the light incident surface includes a first curved surface and a second curved surface, the first curved surface being disposed in the recess in the central portion of the first surface and recessed toward the second surface, the second curved surface being connected to the first curved surface in the recess and extended from the recess, and the first and second curved surfaces have an inflection point at a contact point where the first and second curved surfaces contact each other.

12. The light source module of claim 11, wherein a size of an opening of the recess is greater than a size of the light source.

13. The light source module of claim 11, wherein the light source is a light emitting diode (LED) chip or a light emitting diode package in which the light emitting diode chip is disposed.

14. The light source module of claim 13, wherein the light source comprises an encapsulation part encapsulating the light emitting diode chip.

15. The light source module of claim 11, further comprising a substrate on which the light source and the optical device are disposed.

16. An optical device comprising:
a first surface comprising, in cross-sectional view, a first convex portion, a second convex portion, and a first concave portion disposed therebetween; and
a second surface comprising, in the cross-sectional view, a third convex portion, a fourth convex portion, and a second concave portion disposed therebetween,
wherein the first surface and the second surface face each other,
wherein the first concave portion and the second concave portion protrude toward each other,
wherein the first concave portion includes a first sidewall and a second sidewall that face each other,
wherein the first sidewall includes a first region and a second region,
wherein light passing through the first region is refracted downward with respect to its original direction, and light passing through the second region is refracted upward with respect to its original direction.

17. The optical device of claim 16, wherein the first region of the first sidewall forms a bottom of a recess and the second region of the first sidewall forms an opening of the recess.

18. The optical device of claim 16, wherein the first surface and the second surface are connected to each other with a pair of flanges.

19. The optical device of claim 16, wherein light is emitted through the first surface to the second surface.

20. The optical device of claim 19, wherein the light is incident to the first concave portion of the first surface.
